(19) United States
(12) Patent Application Publication
(10) Pub. No.: US 2003/0079034 A1
(43) Pub. Date: Apr. 24, 2003

(54) System controlling or monitoring communications installation using at least two applications

(75) Inventors: Claus Rist, Bochum (DE); Otto Schroeter, Essen (DE)

Correspondence Address: STAAS & HALSEY LLP, 700 11TH STREET, NW, SUITE 500, WASHINGTON, DC, 20001, US

(73) Assignee: Siemens AG, Munich (DE)

(21) Appl. No.: 10/273,367

(22) Filed: Oct. 18, 2002

(30) Foreign Application Priority Data
Oct. 18, 2001 (DE) 101 51 436.0

(51) Int. Cl. G06F 15/16

(52) U.S. Cl. 709/230; 709/218

(57) ABSTRACT

A communications installation, having a first interface, is controlled and/or monitored using at least two applications, where control or state data are transmitted via a connection that uses the first interface. Connected between the communications installation and the applications is a transmission unit having a second interface to the communications installation and third interfaces to the applications. At least two of the applications can be connected to one of the third interfaces. The first and third interfaces use the same data format for data interchange and make the same functions available. The transmission unit supplies the control or state data in bundled form to the communications installation, on the one hand, or supplies or makes the control or state data available to the applications, on the other hand, according to the transmission direction.

### CROSS REFERENCE TO RELATED APPLICATIONS

This application is based on and hereby claims priority to German Application No. 101 514 36.0 filed on Oct. 18, 2001, the contents of which are hereby incorporated by reference.

### BACKGROUND OF THE INVENTION

Systems in which communications installations are controlled or monitored by applications are known, by way of example, as CTI applications, where CTI stands for computer telephony integration. In order to be able to control or monitor a communications installation using an application, which is generally installed on a PC, the communications installation is equipped with a special interface, the “CTI interface”. The application (the application program) can use this interface to set up a connection, frequently also referred to as a link, to the communications installation, on the one hand, to use commands in the form of control data to influence service features in the communications installation or, on the other hand, to obtain state data about single subscriber lines or all subscriber lines. The state data are in turn requested from the applications using special commands in the form of control data.

If the application installed on the PC is connected directly to the communications installation, reference is made to a “first-party CTI” solution. In order to use a plurality of application programs to access the same communications installation, there are two options: the first option is to use a plurality of CTI interfaces on the communications installation in order to operate a plurality of first-party CTI applications having one link each to the communications installation. The second option is for a telephony server, frequently also referred to as CTI server, to be connected as a central service in the connection path between the communications installation and the PCs for the applications. Such systems are also known as third-party CTI applications. In this case, a section of the application program, the “server component”, is installed on the telephony server. The server component uses a single CTI interface to communicate with the communications installation via a link. In this case, a standardized data format is generally used which is defined in the CSTA Phase III Protocol, for example. The other section of the application program is installed on the user's PC (PC workstation) as a “client component”. The client component communicates with the server component via a network, for example. A third-party CTI application generally has a server component and a plurality of client components which are connected to the server component via a respective link.

The known CTI applications have been found to have the drawback that only relatively few telephony servers or first-party CTI applications can be connected to a communications installation at the same time. The CTI interfaces in customary communications installations have, at the same time, only one connection (link) to a telephony server. Although the CTI interfaces in the form of LAN access facilities, where LAN stands for local area network, form an exception, even they generally support only three simultaneous links to the telephony servers. In addition, the number of CTI interfaces on the communications installations is also limited; it is normally limited to one or two connections.

### SUMMARY OF THE INVENTION

It is an object of the invention to control or monitor a communications installation using a virtually unlimited number of applications.

This object is achieved by a transmission unit connected by first and second interfaces to a communications installation and via third interfaces to applications. At least two of the applications can be connected to one of the third interfaces. The first and third interfaces use the same data format for data interchange and make the same functions available. The transmission unit supplies control and/or state data in bundled form to the communications installation, on the one hand, and/or supplies and/or makes the data available to the applications, on the other hand, according to the transmission direction. The third interfaces are able to be physically independent, i.e. the applications, the central services and the transmission units are installed on different PCs.

A plurality of central services (telephony server) or applications can be operated simultaneously on a communications installation if there is connected between the communications installation and the applications have a transmission unit connected between them with a second interface to the communications installation and third interfaces to the applications, and if at least two of the applications can respectively be connected to one of the third interfaces.

Further use of available central services or of available applications is possible if the first interface and the third interfaces use the same data format for data interchange and make the same functions available.

The loading on the interface for the communications installations is reduced by virtue of the transmission unit supplying the control and/or state data in bundled form to the communications installation, on the one hand, and/or supplying and/or making them available to the applications in question, on the other hand, according to the transmission direction.

Various communications installations and various central services with a standardized interface can be used by virtue of the data format being defined in a CSTA Protocol.

A secure and tried-and-tested type of data transmission is provided if the connection is made via a LAN, particularly an IP network.

If at least one central service is connected between the transmission unit and the applications, a plurality of applications can use a transmission unit simultaneously.

An application can interchange control and state data with a plurality of communications installations by virtue of one of the applications and/or a central service being able to be connected simultaneously to a plurality of transmission units via a LAN.

The programming complexity for creating the transmission units, the central services and/or the applications is reduced if the transmission unit or the transmission units, the central service or the central services and the applications respectively use the same library for communicating with the first interface or the first interfaces and the third interfaces.

It is unnecessary to change configuration data in all the central services or applications when there is a change in the network if a system having a plurality of communications installations is provided with a central database storing the system's configuration data, which are made available to the applications and/or to the central service or the central services.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a system for data interchange; and

FIG. 2 is a block diagram of a system in a network having subnetworks.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

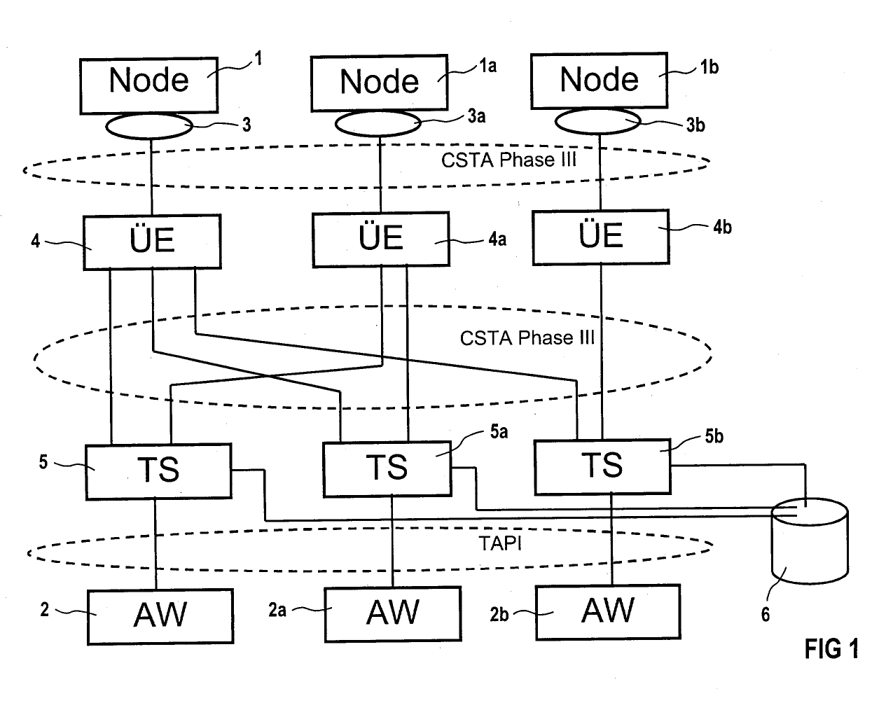

FIG. 1 is a block diagram of a CTI system formed of communications installations 1, 1a, 1b (also: communications nodes) and applications 2, 2a, 2b which are installed on PCs (not shown). The applications 2, 2a, 2b influence service features in the communications installations 1, 1a, 1b using transmitted control data. In addition, operating states of individual subscribers (not shown in the present case) connected to the communications installations 1, 1a, 1b are made available to the applications 2, 2a, 2d.

The communications installations 1, 1a, 1b are equipped with CTI interfaces 3, 3a, 3b for the purpose of interchanging control and state data. The CTI interfaces 3, 3a, 3b are respectively connected to transmission units 4, 4a, 4b which, for their part, are respectively connected to one or more telephony servers 5, 5a, 5b as a central service. Finally, the applications 2, 2a, 2b are connected to the telephony servers 5, 5a, 5b.

The connections between the communications installations 1, 1a, 1b, the transmission units 4, 4a, 4b, the telephony servers 5, 5a, 5b and the PCs with the installed applications 2, 2a, 2b are each logical connections (links) in an IP network, where IP stands for Internet Protocol. Naturally, other known options for transmitting the data are also conceivable, for example using serial interfaces.

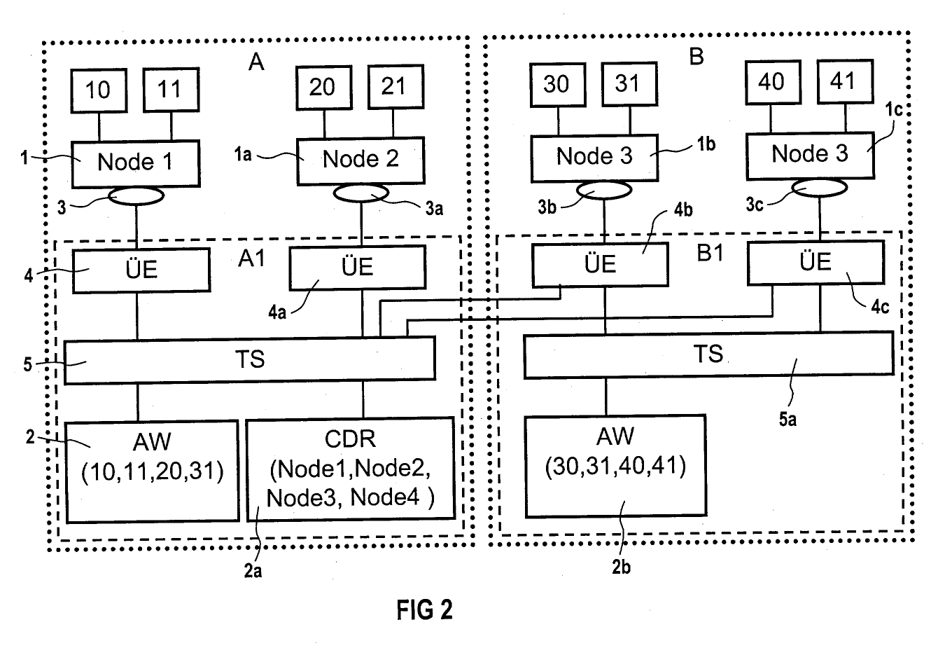

In addition, a database 6 is part of the system, storing configuration data for the communications installations 1, 1a, 1b. The database 6 manages, in particular, directories regarding which subscribers (see FIG. 2) are connected to which of the communications installations 1, 1a, 1b.

The data transmission between the applications 2, 2a, 2b and the communications installations 1, 1a, 1b is described below by way of example using the transmission of control data from the application 2 to the communications installation 1, where a user of the application 2 initiates a change to a service feature for a particular subscriber line which is connected to one of the communications installations 1, 1a, 1b and has an associated call number.

To this end, the application 2 transmits the information about the service feature change and the call number about the telephony server 5 via the subscriber line which is to be changed. In this case, data are transmitted using a programming interface having a data format which is defined on the basis of the TAPI standard, where TAPI stands for telephony application programming interface. The telephony server 5 now sets up a connection to the database 6, transmits the call number of the desired subscriber line and receives, as a response from the database 6, the information that the desired subscriber is connected to the communications installation 1, and also receives the network address of the transmission unit 4 which is associated with the communications installation 1.

The telephony server 5 then generates control data which correspond to the service feature change which is to be made for the subscriber on the communications installation 1. These control data are then transmitted to the transmission unit 4 in line with the network address ascertained from the database 6. To this end, the control data are transmitted in a data format which is defined in the CSTA Phase III Protocol. The transmission unit 4 then transmits the control data to the communications installation 1 via the CTI interface 3, this likewise involving the use of the CSTA Phase III Protocol. The service feature changes are then made in the communications installation 1.

An important function of CTI applications is the obtainment and display of state data relating to particular subscribers or all subscribers connected to a communications installation 1, 1a, 1b. These state data may include, by way of example, information regarding whether a subscriber line is currently busy. This information is obtained by monitoring subscriber lines. The monitoring is done in the communications installation 1, 1a, 1b itself.

If the free or busy state for a subscriber in the communications installation 1 is to be displayed in an application 2, the application 2 sends an appropriate request to the telephony server 5 in order to obtain the state data. In a similar manner to the procedure when transmitting control data, the telephony server 5 requests from the database 6 the network address for the transmission unit 4 which is associated with the communications installation 1. The telephony server 5 sends the request to this network address (the transmission unit 4). The transmission unit 4 manages a list which lists those subscribers in the communications installation 1 which are already being monitored. If the subscriber line in question is not held in this list, the transmission unit 4 transmits a corresponding request to the communications installation 1 with the instructions to monitor the corresponding subscriber. In the communications installation 1, an event-controlled request is then started which, whenever the state of the corresponding subscriber changes, generates a corresponding message which is then sent to the transmission unit 4 via the CTI interface 3. This information is respectively stored there or used for updating an existing list entry, so that the transmission unit 4 always contains a list of current information about the subscriber states of all those subscribers monitored by the applications 2, 2a, 2b.

Whenever the state of a monitored subscriber line changes, a corresponding message is sent from the associated transmission unit 4, 4a, 4b to each of the telephony servers 5, 5a, 5b which needs this information in order to operate the corresponding application 2, 2a, 2b. In this example, it is the telephony server 5 which receives the corresponding information from the transmission unit 4 in order then to forward it to the application 2.

The data format used for transmitting the control and state data is a data format standardized on the basis of CSTA Phase III. The same data format is used in this case both between the telephony servers 5, 5a, 5b and the transmission units 4, 4a, 4b and between the transmission units 4, 4a, 4b and the communications installation 1, 1a, 1b. The transmission units 4, 4a, 4b and the telephony servers 5, 5a, 5b also use the same software library, where DLL stands for dynamic link library, based on ASN.1, where ASN.1 stands for abstract syntax notation 1, a standard based on CCITT X.208, X.680, for communication.

An example of a system in which the communications installations 1b, 1c are accessed using more than one link in each case is shown schematically in FIG. 2. A network is formed from four communications installations 1, 1a, 1b, 1c, with the associated transmission units 4, 4a, 4b, 4c, the telephony servers 5, 5a, the applications 2, 2a, 2b and the subscribers 10, 11, 20, 21, 30, 31, 40, 41. The communications installations 1, 1a and the communications installations 1b, 1c form, together with the respectively associated transmission units 4, 4a and 4b, 4c, the subscribers 10, 11, 20, 21 and 30, 31, 40, 41, the telephony servers 5 and 5a and the applications 2, 2a and 2b, two units which are physically and functionally separate and are referred to as islands A, B. Each island A, B has an application server A1, B1 which combines the functionality of the respective transmission units 4, 4a and 4b, 4c, of the telephony servers 5 and 5a and of the applications 2, 2a and 2b in one device.

A central database 6 is not provided in this exemplary embodiment, because in this case the association between the subscriber 10, 11, 20, 21, 30, 31, 40, 41 and the communications installations 1, 1a, 1b, 1c and the association between the network addresses and the transmission units 4, 4a, 4b, 4c are administered in the telephony servers 5, 5a themselves.

In island A, an application 2a in the form of call data recording CDR, where CDR stands for call detail recording, is connected to the telephony server 5 for the purpose of charge recording. Call data recording for calls by all subscribers 10, 11, 20, 21, 30, 31, 40, 41 requires not just state data from the communications installations 1, 1a on the intrinsic island A, that is to say data from the transmission units 4, 4a, but also those from the transmission units 4b, 4c. For this reason, the transmission units 4b, 4c serve two respective links at the same time in the direction of the telephony servers 5, 5a. While only one link is respectively required between the communications installations 1, 1a and the associated transmission units 4, 4a, each of the transmission units 4, 4a makes two respective CTI interfaces 3, 3a, 3b, 3c available to the telephony servers 5, 5a.

The additional link to the transmission unit 4b is also used by the application 2, which accesses the service features of the communications installation 3 to which the subscriber 31 is connected. The application 2 thus indirectly simultaneously accesses the CTI interfaces 3, 3a, 3b, 3c of a plurality of communications installations 1, 1 a, 1b, as though just a single communications installation 1, 1a, 1b were connected to the telephony server 5, so to speak. This implementation can also be referred to as a “one-system image”, in which it is possible to use such applications 2, 2a, 2b as are known from CTI applications with just one communications installation 1, 1a, 1b, 1c. In this case, the communications installations 1, 1a, 1b, 1c communicate with the respective transmission units 4, 4a, 4b, 4c as though just one telephony server 5, 5a were directly connected to each CTI interface 3, 3a, 3b, 3c in each case, which means that the normal CTI interfaces 3, 3a, 3b, 3c of the communications installations 1, 1a, 1b, 1c can consequently be used.

The invention has been described in detail with particular reference to preferred embodiments thereof and examples, but it will be understood that variations and modifications can be effected within the spirit and scope of the invention.

What is claimed is:

1. A system for at least one of controlling and monitoring at least one communications installation, each having a first interface, using at least two applications, comprising:
at least one transmission unit having a second interface for communication with the first interface of the at least one communications installation and third interfaces coupled to the applications, the first and third interfaces using a predefined data format for data interchange and each providing a set of predefined functions;
at least one first connection, between the first and the second interfaces, to transmit at least one of control and state data in bundled form from said transmission unit to the at least one communications installation; and
second connections between at least two of the applications and one of the third interfaces, to at least one of transmit and make available to the applications the at least one of control and state data from said transmission unit.

2. The system as claimed in claim 1, wherein the predefined data format is in accordance with a CSTA protocol.

3. The system as claimed in claim 2, wherein at least one of said first and second connections includes a local area network.

4. The system as claimed in claim 3, wherein said local area network is an internet protocol network.

5. The system as claimed in claim 3, wherein said second connections further includes at least one central service.

6. The system as claimed in claim 5,
wherein said at least one transmission unit includes a plurality of transmission units, and
wherein at least one of the applications and said at least one central service can be connected simultaneously to at least some of said transmission units via said local area network.

7. The system as claimed in claim 5, wherein said at least one transmission unit, said at least one central service and the applications use a single library for communicating with the first and third interfaces.

8. The system as claimed in claim 7, wherein the at least one communications installation includes a plurality of communications installations, and
wherein said system further comprises a central database storing configuration data for said system, the configuration data being made available to at least one of the applications and said at least one central service.

9. A system for at least one of controlling and monitoring at least one communications installation, each having a first interface, using at least two applications, comprising:
a second interface coupled to the first interface of the at least one communications installation;
third interfaces, coupled to the applications with at least one of said third interfaces coupled to at least two of the applications, the first and third interfaces using a predefined data format for data interchange and each providing a set of predefined functions;
at least one transmission unit, coupled to said second and third interfaces, to transmit at least one of control and state data in bundled form via said second interface to the at least one communications installation, and to at least one of transmit and make available to the applications the at least one of control and state data via said third interfaces.

10. The system as claimed in claim 9, wherein the predefined data format is in accordance with a CSTA protocol.

11. The system as claimed in claim 10, wherein said system further comprises at least one local area network connecting at least one of said first to second interfaces and said third interfaces to the applications.

12. The system as claimed in claim 11, wherein said at least one local area network includes at least one internet protocol network.

13. The system as claimed in claim 11, further comprising at least one central service connected between said third interfaces and the applications.

14. The system as claimed in claim 13,
wherein said at least one transmission unit includes a plurality of transmission units, and
wherein at least one of the applications and said at least one central service can be connected simultaneously to at least some of said transmission units via said at least one local area network.

15. The system as claimed in claim 13, wherein said at least one transmission unit, said at least one central service and the applications use a single library for communicating with said first and third interfaces.

16. The system as claimed in claim 15, wherein the at least one communications installation includes a plurality of communications installations, and
wherein said system further comprises a central database storing configuration data for said system, the configuration data being made available to at least one of the applications and said at least one central service.
